(19) United States
(12) Patent Application Publication
(10) Pub. No.: US 2007/0005416 A1
(43) Pub. Date: Jan. 4, 2007

(54) Systems, methods, and computer readable media for managing loyalty programs

(76) Inventors: S. Brigid Jackson, Chesterfield, VA (US); Amy Gonzalez, Arlington, VA (US); Carolyn McCarty, Richmond, VA (US); Brent David Sower, Chester, VA (US); Chitra Jain, Glen Allen, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/169,672

(22) Filed: Jun. 30, 2005

(51) Int. Cl. G06Q 30/00

(52) U.S. Cl. 705/14

(57) ABSTRACT

Systems and methods are provided for processing a request to capture funds from a financial account: In one embodiment, a method is provided that includes receiving a request for a merchant to capture funds from a customer's financial accounts and determining, based on the request, whether the customer is a member of a program (such as a loyalty program) offered by the merchant. If the customer is a member of a program offered by the merchant, then an indication is provided of the customer's membership to the merchant. If the customer is not a member of a program offered by the merchant, then the request is forwarded for authorization.

### TECHNICAL FIELD

The present disclosure generally relates to systems and methods for managing financial transactions and, more specifically, the invention relates to systems and methods for administering loyalty programs, such as merchant or retail loyalty programs.

### BACKGROUND

Merchants, including retail chains, frequently offer their customers membership in “loyalty” or “affinity” programs, whereby participating customers may earn rewards based on their transactions with the merchant or its affiliates. For example, a merchant, such as a grocery chain, may give discounts to members at the point of sale, based on their current purchases or history of purchases with the merchant. In return, the merchant is able to track customers' purchases individually and in the aggregate, and thus gain useful insight into their buying habits, brand preferences, etc.

In order to obtain the rewards through a loyalty program, customers are usually required to prove membership by producing a loyalty identification (e.g., a magnetic card, bar-coded tag, etc.). However, customers find it bothersome to have to carry a card for each loyalty program in addition to their bank cards or credit cards. Although many merchants offer customers the option of proving membership by entering their telephone number at the time of purchase, customers are increasingly leery of disclosing their telephone number. Further, without some token of membership to remind the customer that they are a member of a particular merchant's loyalty program, they may forget to enter their telephone number, and so fail to obtain their rewards. In either case, the requirement to provide some indicia of membership may cause delays in the checkout line as customers search for the right membership card, or key in their telephone number, in addition to tendering payment.

Some merchants, such as large retail chains, offer co-branded credit cards that offer customers a flat discount (e.g., 3%) on all purchases made from the merchant using the card. With this arrangement, customers are not required to carry indicia of membership, other than the card. However, the amount of credit available to each customer is finite, as is the amount of space in the customer's wallet or purse. Consequently, the typical customer is unlikely to carry more than two or three such cards. This arrangement is also disadvantageous from the merchant's point of view in that while the flat discount may generally encourage customers to patronize the merchant, rather than its competitors, it may not be used to encourage customers to purchase particular goods, e.g., which the merchant has over-stocked.

Merchants have also formed reward coalitions in which customers are rewarded for purchases from any of a number of participating merchants. For example, the UPromise® program rewards customers by depositing a flat percentage of their payments to participating merchants in a college savings account. Similarly, the Nectar™ program awards points based on the volume of customers' purchases at participating merchants. Customers may redeem their points for merchandise selected from a catalog.

Such arrangements are advantageous in that they do not require customers to carry a separate card for each merchant in the program. However, here again, such flat-rate rewards may not be used to encourage customers to purchase particular goods. Further, because the rewards in such programs are redeemed after the fact, rather than at the point of sale, they have not been effective in engendering loyalty to the individual merchants in the coalition. In addition, although each merchant in the coalition may collect data on their own transactions with customers, this data is typically not shared with other members of the coalition. Consequently, merchants are not able to obtain a complete picture of their customers' needs and preferences.

Accordingly, there is a need for improved systems and methods for providing customers with access to the benefits of loyalty programs.

### SUMMARY

Systems, methods, and computer-readable media consistent with the present disclosure address these and other needs by providing mechanisms by which a plurality of merchants may participate in a consolidated loyalty system that offers customers access to the benefits of membership in an individual merchant's loyalty program using a single access key, such as the account number of a bank card. Further, systems and methods consistent with the present disclosure provide mechanisms that allow the individual merchants participating in the consolidated loyalty system to provide rewards to their customers at the point of sale. In addition, systems and methods consistent with the present disclosure provide mechanisms for sharing customer data between participating merchants.

Consistent with the present disclosure, a method for processing a request is provided. The method comprises receiving, at a consolidation platform, a request from a merchant to capture funds from a customer's financial account; determining, at the consolidation platform, whether the customer is a member of a loyalty program offered by the merchant based on the request to capture funds; if the customer is a member of a loyalty program offered by the merchant, providing an indication of the customer's membership to the merchant; and if the customer is not a member of a loyalty program offered by the merchant, forwarding the request for authorization.

Consistent with the present disclosure, a system is provided. The system may comprise a consolidation platform in communication with a plurality of merchants over a network. The consolidation platform may comprise a processor configured to: receive a request from one of the plurality of merchants to capture funds from a customer's financial account; determine, based on the request, whether the customer is a member of a loyalty program offered by the merchant; and if the customer is a member of a loyalty program offered by the merchant, provide an indication of the customer's membership to the merchant over the network; and if the customer is not a member of a loyalty program offered by the merchant, forward the request for authorization to an authorization platform for processing of the request.

It is to be understood that both the foregoing general summary and the following detailed description are exemplary and explanatory only and are not restrictive of the disclosure, as claimed. Further features and/or variations may be provided in addition to those set forth herein. For example, the present disclosure may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1A is a block diagram that schematically illustrates an exemplary system environment;

FIG. 1B is a block diagram that schematically illustrates an exemplary merchant environment;

FIG. 2 is a block diagram that schematically illustrates an exemplary loyalty consolidation platform;

FIG. 3 is a flow chart that illustrates an exemplary method for administering loyalty programs; and

FIG. 4 is a diagram showing an exemplary message flow consistent with the method of FIG. 3.

### DESCRIPTION OF THE EMBODIMENTS

Reference will now be made in detail to exemplary embodiments of the present disclosure, examples of which are illustrated in the accompanying drawings. Wherever possible, the same reference numbers will be used throughout the drawings to refer to the same or like parts.

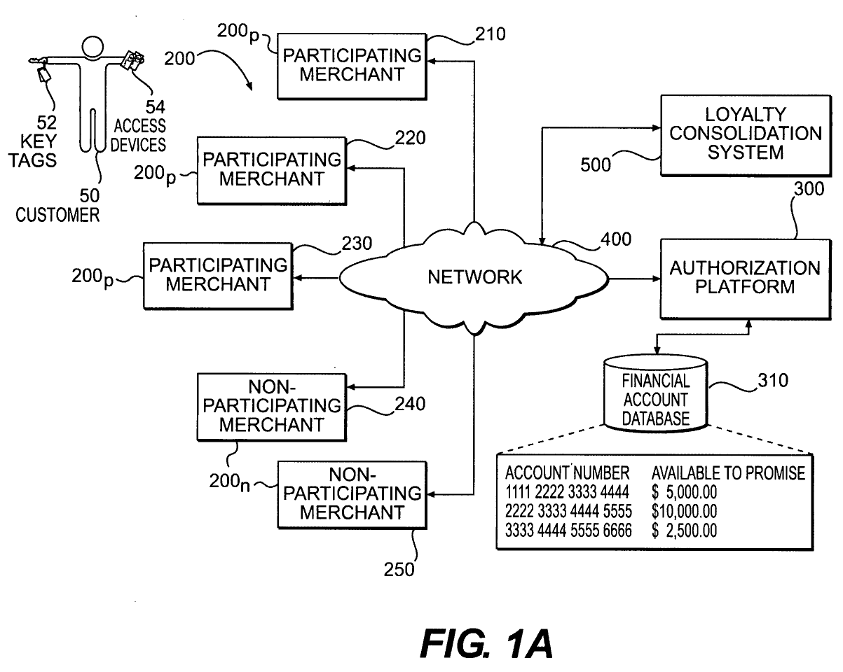

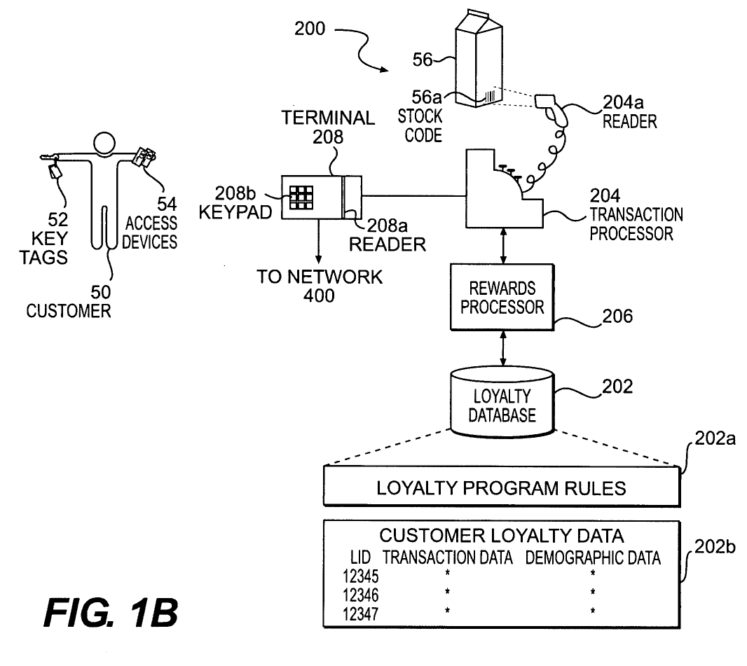

FIG. 1A is a block diagram that schematically illustrates an exemplary system environment 100, consistent with certain features and principles of the present invention. As shown in FIG. 1A, system environment 100 may include a plurality of merchants 210, 220, 230, 240, and 250 in communication with a transaction authorization platform 300 and a loyalty consolidation system 500. Communication between these components may be supported over a network 400, as further described herein.

As illustrated in FIG. 1A, a customer 50 may be a member of loyalty programs offered by one or more of the plurality of merchants 210-250. By way of example, assume that merchants 210, 220 and 230 offer access to the benefits of their individual loyalty program through loyalty consolidation system 500, consistent with the present invention. Such merchants are collectively referred to herein as “participating” merchants 200p. By contrast, assume that merchants 240 and 250 do not offer such access, and use conventional solutions for implementing their respective loyalty programs. Such merchants are referenced collectively herein as “non-participating” merchants 200n. In the description that follows, the term “merchants” 200 is used to collectively refer to merchants 210-250, whether participating or non-participating.

Customer 50 may carry a plurality of loyalty identifications (LIDs), such as bar-coded key-tags 52, which may encode an LID number or other identifier as proof of membership in the programs of non-participating merchants 200n. A description of how key-tags 52 can be used by customer 50 to interact with a non-participating merchant is provided below with reference to FIG. 1B.

Customer 50 may also have one or more account keys that provide the customer with access to various financial accounts (e.g., credit or debit accounts). An account key may comprise any tangible or intangible device, data, or metric that provides access to a financial account. For example, the key may be an account number or biometric data, such as a fingerprint.

The account key for a particular account may be imprinted or encoded on an account access device 54 provided to the customer 50. Access device 54 may be any suitable type of device. For example, access device 54 may be a magnetic card, smart card, RFID tag, bar code, or other device. Access device 54 may also include an encoded electronic data signal, such as a telephone caller-ID signal, or digital signature; that may be used to provide access to a financial account.

Authorization platform 300 may process requests from merchants 200 to capture funds from a customer's financial account, e.g., when a customer 50 tenders payment using a credit or debit card, or other financial account. Authorization platform 300 may be operated by a so-called “clearinghouse” or “acquirer,” who may authorize and/or settle account transactions between merchants 200 and various financial institutions (“issuers”) who issue such financial accounts to customers 50. Alternatively, authorization platform 300 may be operated by an issuer of such accounts, such as a bank. Although only one authorization platform 300 is shown in FIG. 1A, it will be understood that multiple authorization platforms 300 may be linked to network 400 and operated in parallel by the same or different entities.

Authorization platform 300 may have access to a financial account database 310. As illustrated in FIG. 1A, account database 310 may contain a record of the amount of available credit (if a credit account) or balance of funds (if a debit account) for each financial account for which authorization platform 300 may authorize transactions. The various financial accounts may be identified in database 310 by their account number. This number may be encoded, for example, on the account access device 54 provided to customer 50 for that account.

Network 400 may include any type of communications network. For example, network 400 may include a secure credit network, a local area network (LAN), a public telephone switching network (PTSN), a wide area network (WAN), such as the Internet, etc., or any combination of such networks. In an exemplary embodiment of the present disclosure, network 400 may include an automated clearinghouse (ACH) network that enables merchants 200 to communicate with authorization platform 300.

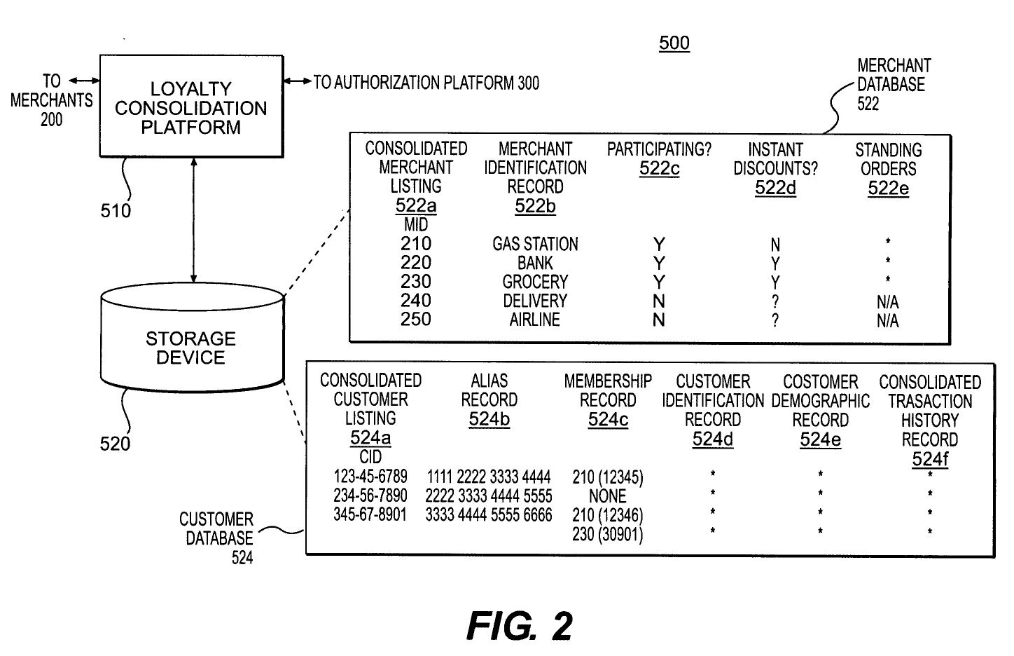

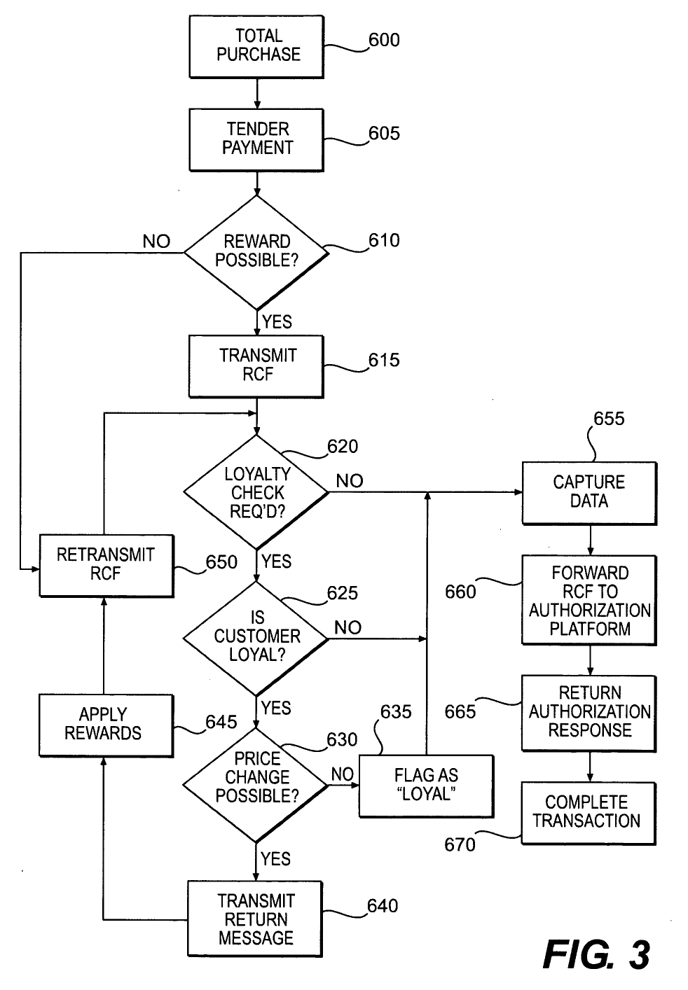

The system environment for a representative merchant 200 is shown in expanded form in FIG. 1B. As shown in FIG. 1B, representative merchant 200 may be equipped with a loyalty database 202, a transaction processor 204, a rewards processor 206 and a network terminal 208. Both participating merchants 200p and non-participating merchants 200n may be equipped with similar infrastructure to that depicted in FIG. 1B. However, the equipment of participating merchants 200p may be additionally configured to interact with loyalty consolidation system 500, consistent with embodiments of the invention (see, e.g., FIGS. 2-3), while the equipment of non-participating merchants 200n may be configured to operate according to conventional methods.

Loyalty database 202 may contain data and/or information used by processors 204 and/or 206 in processing transactions or rewards for each customer 50. As shown in FIG. 1B, database 202 may include customer loyalty data 202b and a set of loyalty program rules 202a. Customer loyalty data 202b may include transaction data related to individual customers' purchases with the representative merchant 200 and/or demographic data which each customer 50 has shared with the representative merchant 200. As illustrated in FIG. 1B, each customer's individual loyalty data 202b may be indexed, e.g., by the customer's LID number for the representative merchant's rewards program. Loyalty program rules 202a may contain instructions and/or data for applying rewards to an individual transaction with a customer, as discussed below.

Transaction processor 204 may be any type of device used by merchants 200 to process transactions with each customer 50. For example, transaction processor 204 may be implemented with a cashier's register, self-service checkout station, or similar device operable to, e.g., total customers' purchases, calculate any applicable taxes, print receipts, etc. Transaction processor 204 may include a reader 204a, such as a bar-code reader, RFID reader, or similar device. Reader 204a may be used, e.g., for reading a stock code 56a (such as a United Product Code (UPC) bar code or RFID) from a purchased item 56. When the stock code 56a for a particular item 56 is read using reader 204a, transaction processor 204 may automatically identify the item 56 from a listing of the merchant's inventory (e.g., in database 202) and add the price of the item 56 to the transaction total. Reader 204a may also be used to read the LID number encoded on the customer's key-tag 52 for the merchant's loyalty program.

Rewards processor 206 may administer the representative merchant's individual loyalty program. For example, rewards processor 206 may be implemented by a computer or program in communication with transaction processor 204. For each transaction processed by transactions processor 204, reward processor 206 may determine the rewards (if any) due to a particular customer 50 in accordance with the loyalty program rules 202a maintained by representative merchant 200.

Loyalty program rules 202a may set forth both the types of rewards offered to customers and the criteria for earning such rewards. Loyalty program rules 202a may reward customers based on their transactions with the merchant 200. For instance, the loyalty program rules 202a for a particular merchant may apply advertised or unadvertised discounts, or give coupons, points, certificates, etc., for a particular transaction based on, for example, the customer's current purchases (e.g., using data available from transaction processor 204), history of purchases and/or demographic information (e.g., as reflected in customer loyalty data 202b). However, it is to be understood that the present invention is not limited in application to any particular type of loyalty program or set of loyalty program rules 202a. One of skill in the art will recognize that the types of rewards and the criteria for earning rewards from the loyalty program offered by a particular merchant 200 may vary in accordance with the merchant's business needs.

Terminal 208 may allow merchant 200 to communicate with authorization platform 300 over network 400. Terminal 208 may include a POS terminal adapted to process bank card transactions. For example, terminal 208 may include a reader 208a, such as a magnetic card reader, RFID reader, biometric reader, etc., for automatically reading data from a bank card and/or other account access device 54 that a customer may use to tender payment. Terminal 208 may also include a keyboard or keypad 208b for entering such data manually, e.g., into an electronic form on a web page linked to authorization platform 300. Alternatively, terminal 208 may be implemented using a telephone, whereby the merchant 200 may communicate with an Audio Response Unit (ARU) linked to authorization platform 300, e.g., by touchtone entry, or by speaking to an operator who is in turn linked to authorization platform 300, e.g., using a data entry terminal (not shown).

As shown in FIG. 1B, rewards processor 206, terminal 208 and transaction processor 204 may be implemented by separate devices. Alternatively, rewards processor 206 and/or terminal 208 may be operatively linked to or integrated with transaction processor 204 or each other.

A representative transaction by a non-participating merchant 200n, using conventional methods for administering a loyalty program, will now be described with reference to FIGS. 1A and 1B. In such a transaction, a customer 50 may present an item 56 to the non-participating merchant 200n for purchase. Merchant 200n may total the price of the item 56 using transaction processor 204. After the transaction has been totaled, merchant 200n may inquire as to whether the customer 50 is a member of the merchant's loyalty program. If so, then customer 50 may prove membership, e.g., by presenting their key-tag 52 for the merchant's loyalty program to be read by reader 204a.

Rewards processor 206 may then retrieve the LID encoded on the key-tag 52 and then search customer loyalty data 202b for a record of the customer's LID. If such a record is found, indicating that customer 50 is a member of the merchant's loyalty program, then rewards processor 206 may apply loyalty program rules 202a to the transaction. For example, rewards processor 206 may discount the price on the item 56, thus reducing the total. Rewards processor 206 may also update the customers' loyalty data 202b to reflect the purchases made in this transaction.

Customer 50 may then pay the total, e.g., by authorizing merchant 200n to charge a financial account, such as a credit or debit account. For example, customer 50 may present an account access device 54 to terminal reader 208a. Terminal 208 may then read the account number encoded on the access device 54 and send a “request to capture funds” from the account to authorization platform 300. The request may identify the account number of the financial account, the issuing financial institution (e.g., by Bank Identification Number (BIN)), the transaction price, and merchant 200n (e.g., by a merchant identification number used by authorization platform 300 to identify merchants 200 for settlement purposes).

Authorization platform 300 may receive the request, determine whether the account has sufficient credit or funds available to cover the transaction price, and transmit an “authorization response,” e.g., APPROVED or DECLINED, to merchant 200n as appropriate. If the request is approved, authorization platform 300 may also return an authorization code (e.g., a six digit code) that serves as the merchant's proof of authorization. Authorization platform 300 may then transfer an amount of credit or funds equal to the transaction price from the issuing financial institution to merchant 200n, so as to settle the transaction on customer's behalf.

Note that, with the conventional methods, customer 50 may be required to produce both a key-tag 52 to obtain the rewards offered by the non-participating merchant 200n and an account access device 54 in order to tender payment. Note also that the non-participating merchant 200n typically only has access to customer loyalty data 202b gathered from its own transactions with the customer 50.

Embodiments consistent with the present invention provide systems and methods by which a plurality of merchants may participate in a consolidated loyalty system that offers customers access to the benefits of membership in the individual merchants' loyalty programs using a single access key, such as the account number of a bank card. In addition, the consolidated loyalty system may facilitate the sharing of customer loyalty data between participating merchants. Consequently, systems and methods consistent with the present invention may solve one or more of the deficiencies of conventional methods for administering such loyalty programs.

FIG. 2 is a block diagram that schematically illustrates a loyalty consolidation system 500, consistent with certain features and principles of the present invention. Exemplary embodiments of loyalty consolidation system 500 may operate compatibly with the infrastructure of non-participating merchants 200n, yet provide customers with enhanced access to the benefits of membership in the rewards programs offered by participating merchants 200p.

As shown in FIG. 2, loyalty consolidation system 500 may include a consolidation platform 510 and a storage device 520. Consolidation platform 510 may be implemented by a general purpose computer (e.g., a personal computer, network computer, server, mainframe computer, etc.) including a processor (not shown) that may be selectively activated or configured by a computer program (e.g., software) to perform one or more methods consistent with the present invention. Consolidation platform 510 may also be implemented by a distributed network of such computers. Alternatively, consolidation platform 510 may be implemented by a computer or circuit that is specially constructed to perform such methods.

As indicated in FIG. 2, consolidation platform 510 may be in communication with one or more merchants 200. In an exemplary embodiment, consolidation platform 510 may communicate with merchants 200 over network 400, i.e., the same network that merchants 200 use to communicate with authorization platform 300 (as indicated in FIG. 1A). Alternatively, consolidation platform 510 may communicate with merchants 200 over a parallel network or networks (not shown).

In one embodiment, consolidation platform 510 may be in communication only with participating merchants 200p. Alternatively, consolidation platform 510 may be implemented for communication with both participating merchants 200p and non-participating merchants 200n. For example, consolidation platform 510 may be in communication with all merchants 200 who are connected to network 400, whether participating or non-participating.

Consolidation platform may also be in communication with authorization platform 300, either directly or through network 400. Alternatively, consolidation platform 510 may not be in communication with authorization platform 300. In that case, consolidation platform 510 and authorization platform 300 may communicate with merchants 200 in parallel, either over network 400 or over parallel communications networks.

In one embodiment, consolidation platform 510 and authorization platform 300 may be implemented by the same computer or network. For example, consolidation platform 510 and authorization platform 300 may be jointly operated by a clearinghouse or issuer. Alternatively, consolidation platform 510 and authorization platform may be operated separately and/or by separate entities. The entity that operates the consolidation platform is referred to herein as the “consolidator.” However, it will be understood that the consolidator may be the same entity as, e.g., the clearinghouse or issuer who may operate authorization platform 300. It will also be understood that multiple consolidation platforms 510 and/or authorization platforms 300 may be operated in parallel by the same or different entities.

Storage device 520 may contain instructions for configuring consolidation platform 510 to carry out one or more methods consistent with the present invention. Storage device 520 may also store data for use in the performance of such methods, as discussed below. Storage device 520 may be implemented by any number of computer-readable media linked to consolidation platform 510.

Consistent with the present disclosure, “computer-readable media” may include any type of media (e.g., RAM or ROM) that is capable of carrying instructions or data that may be used to configure consolidation platform 510 to perform methods consistent with the present invention. Computer-readable media may include both tangible and intangible media. For example, computer-readable media may include physical media (e.g., a punch card), magnetic media (e.g., a magnetic disk or tape), optical media (e.g., an optical disk), a carrier wave (e.g., from a computer or network, such as the Internet), etc.

Storage device 520 may maintain a merchant database 522 and a customer database 524. Although merchant database 522 and customer database 524 are illustrated as two separate databases, they may instead be combined in a single database or distributed among a greater number of databases as may be convenient.

Merchant database 522 may contain information related to merchants 200. As illustrated in FIG. 2, each merchant 200 may be assigned a merchant identifier (MID). The MID may be any identifier sufficient to differentiate the plurality of merchants in merchant database 522. In one embodiment, the MID may be identical to a merchant identification number used by authorization platform 300 to identify merchants 200 for settlement purposes. Alternatively, the MID may be another suitable identifier. For example, where merchants 200 communicate with consolidation platform 510 over a telephone network, the MID may be the merchant's telephone number (which consolidation platform 510 may identify, e.g., using a caller identification device). Alternatively, e.g., where the particular merchant offers more than one loyalty program through the consolidated system 500, the MIDs may identify the merchants' various loyalty programs, rather than the merchants themselves.

Merchant database 522 may maintain a consolidated listing 522a of those merchants 200 who are in communication with consolidation platform 510 (e.g., by MID). For each merchant in listing 522a, merchant database 522 may also contain any of a number of cross-references to further information related to the merchant identified by that MID. For example, merchant database 522 may include a merchant identification record 522b that identifies each merchant, e.g., by name, address, web site, telephone number, type of business (retailer, gas station, grocer, etc.), or other identifying or demographic information.

Merchant database 522 may also provide an indication 522c as to whether each merchant is participating in the loyalty consolidation system 500, or is non-participating. As shown in FIG. 2, for example, merchants 210, 220 and 230 are indicated as participating in the loyalty consolidation system 500 (by a “Y” notation), while merchants 240 and 250 are indicated as non-participating (by an “N” notation). Alternatively, e.g., if consolidation platform 510 is only in communication with participating merchants 200p, listing 522a may be limited to participating merchants 210, 220 and 230 and indication 522c may be omitted.

For each merchant in listing 522a, merchant database 522 may also contain any of a number of cross-references to further information related to that merchant. For example, such information may be contained in a number of records or entries that may be linked to the merchant's MID in any suitable manner. As illustrated in FIG. 2, such records may include an instant discounts indication 522d, and a record of standing orders 522e.

Instant discounts indication 522d may provide an indication as to whether a participating merchant's loyalty program rules 202a provide rewards (such as instant discounts or coupons on items being purchased) that may change the price of a transaction. As shown in FIG. 2, for example, the loyalty program rules 202a for merchants 220 and 230 do provide for such discounts (indicated by a “Y” notation), while the loyalty program rules 202a for merchant 210 do not (indicated by an “N” notation). Further, because merchants 240 and 250 are non-participating, the content of their loyalty program rules (if any) is unknown (indicated by a “?” notation).

Standing orders record 522e may contain standing orders for customer information that participating merchants 200p have placed with consolidation platform 510. Such standing orders are discussed below in connection with FIG. 3.

Customer database 524 may maintain a consolidated listing 524a of customers. As illustrated in FIG. 2, each customer 50 referred to in database 524 may be assigned a consolidated identifier (CID). The CID may be any identifier sufficient to differentiate the plurality of customers in customer database 524. For instance, the customer's social security number may be used as their CID. Alternatively, the consolidator may employ a unique identification system for customers.

In one embodiment, the CID may be encoded or imprinted on an access device 54 (such as a magnetic-stripe card, smart card, RFID tag, etc.), which may be provided to the customer for use in accessing the benefits of membership in the loyalty programs of participating merchants 200p. For example, the CID may be encoded on a bank card that is issued to the customer 50 by the consolidator. The CID may be distinguished from the account number of the financial account. In the case of a credit or debit card, for example, the CID may be encoded in the third track of an ISO/IEC Standard 7811 bank card. Alternatively, the CID may be encoded in a separate magnetic stripe or bar-code imprinted on the card.

In another embodiment, the CID may be encoded on one of the customer's existing access devices 54. For example, the consolidator or a participating merchant may encode the CID on the third track of one of the customer's existing bank cards. Alternatively, the CID may be encoded in a bar-code that may be imprinted on one or more stick-on labels, which the customer may then apply, e.g., to one or more of their bank cards for convenient access during transactions.

However, in one embodiment, it is not necessary to provide customers with yet another access device 54. Instead, system 500 may provide customers 50 with access to the consolidated loyalty system using one of their existing access keys or devices 54, as discussed below. In this case, the CID may be used solely for internal reference by the consolidator and/or participating merchants 200p.

For each customer 50 in listing 524a, customer database may contain any of a number of cross-references to further information related to that customer. The information may be contained in a number of records or entries that may be linked to the customer's CID in any suitable manner. As illustrated in FIG. 2, such records may include an alias record 524b, a memberships record 524c, a customer identification record 524d, a customer demographic record 524e, and/or a consolidated transaction history record 524f.

Alias record 524b may include information related to other identifiers associated with the customer 50. For example, record 524b may include one or more account numbers of financial accounts held by the customer 50. In the case of a credit or debit account, for instance, record 524b may record the ANSI Standard X4.13-1983 sixteen-digit account number. Accounts whose account numbers have been associated with the customer in alias record 524b are referred to herein as “associated” accounts. Consistent with one embodiment, a customer 50 may obtain access to the benefits of the loyalty programs of participating merchants 200p by tendering payment using the access device 54 for an associated account, as discussed below. By providing for such dual use of the customer's existing access devices, systems and methods consistent with the present invention may lighten the load on customers' key-chains and wallets, and ensure that customers obtain the benefits of the loyalty programs of which they are a member.

Memberships record 524c may contain information identifying the loyalty programs within the consolidated system 500 to which the customer 50 is a member. For example, record 524c may contain a list of the MIDs corresponding to the participating merchants 200p whose loyalty programs the particular customer 50 has joined. If a particular merchant has their own identifier for the particular customer (such as an LID number), memberships record 524c may also contain a reference to this identifier (indicated parenthetically in FIG. 2).

Customer identification record 524d may contain information identifying the particular customer 50. For example, record 524d may contain entries for the customer's name, address, telephone number, email address, etc., and/or other identifying information which merchants 200 may find useful.

Customer demographic record 524e may contain demographic information related to the customer 50. For example, record 524e may contain entries for the customer's age, sex, income, marital status, children, pets, interests, hobbies and/or preferences, etc., or other demographic information which merchants 200 may find useful.

Consolidated transaction history record 524f may contain information related to the customers prior transactions with merchants 200. For example, record 524f may contain information related to merchants visited (e.g., by MID), dates visited, items purchased (e.g., by SKU number), payment methods and/or credit records, etc., or other transactional information related to customer 50 which merchants 200 may find useful.

Information about a particular customer 50 may be added to records 524b-f when the customer is added to listing 524a, and may be updated whenever the customer completes a transaction with a merchant 200. It is to be understood that it is not necessary to have information for each of records 524b-f in order to add a customer to listing 524a. For example, a customer 50 may be added to listing even though all that is known about the customer is the account number of a financial account that they have used for a transaction with a merchant 200, as discussed below.

Customers may be added to listing 524a actively or passively. For example, a customer 50 may be added to listing 524a when they actively join the loyalty program of a participating merchant 200p, e.g., by providing their identifying information and any demographic or other information that the participating merchant 200p requires in exchange for membership. The participating merchant 200p may then forward the customer's information to consolidation platform 510 for entry into database 524. Consolidation platform 510 may then enter the customer's information in the appropriate records 524b and d-f and list the forwarding merchant in the customer's memberships record 524c. Alternatively, the participating merchant 200p may enter the customer's information in database 524 directly, e.g., via terminal 208 or another terminal linked to consolidation platform 510.

As another example, customers 50 may actively join one or more of the loyalty programs of participating merchants 200p by contacting the consolidator directly. For example, the consolidator may provide an electronic form (e.g., accessible over the Internet) that allows a customer 50 to provide any necessary identifying and/or demographic information and further to join one or more of the loyalty programs offered by participating merchants 200p, e.g., by checking boxes on the form. Alternatively, customers may use such forms to indicate their desire to sign up those loyalty programs which meet certain criteria. For example, a customer 50 may indicate that they wish to join the loyalty programs offered by those participating merchants 200p who have locations within a certain radius of the customer's home, or who agree not to further disseminate the customer's personal or demographic information.

The consolidator may require that customers meet certain criteria in order to actively join the loyalty consolidation system 500. For instance, the consolidator may require customers to have a credit account with a particular issuer, or to pay a membership fee, in order to join the consolidated program. Further, participating merchants 200p may require the customer to meet certain demographic or other criteria in order to actively join their respective loyalty programs within the consolidation system 500.

Customers may also be passively registered by a participating merchant 200p or by the consolidator. Passive registration may be limited to those customers who have provided consent, either directly to the participating merchant or consolidator, or in, e.g., the account-holder agreement with the issuer of a bank card used for a transaction with a merchant 200.

For example, a participating merchant 200p may passively register a customer 50 who performs a credit or debit transaction with the merchant by forwarding, e.g., the account number of the financial account that the customer used for the transaction for entry into alias record 524b. A particular merchant may limit such passive registrations to customers who meet certain criteria. For example, the merchant may only register such customers where the transaction total is higher than a certain amount, or where the transaction involves particular goods or services.

In addition, a consolidator may passively register customers for the loyalty programs of one or more participating merchants 200p. For example, a consolidator who is also an issuer of, e.g., bank cards, may passively register its account-holders for the loyalty program of some or all of the participating merchants 200p. The consolidator may register customers for the loyalty programs of participating merchants 200p based on criteria set by the individual merchants. For instance, the consolidator may passively register those customers who match certain demographic criteria set by the individual merchants.

In one embodiment, consolidation platform 510 may passively register customers who perform a credit or debit transaction at a non-participating competitor 200n of a participating merchant 200p. Alternatively, consolidation platform 510 may add such customers to the database 524 in order to collect customer history data (for record 524f), without registering them for the loyalty program of any particular participating merchant 200p.

Once a customer 50 has been added to database 524, they may be given an identification (e.g., their CID) and/or password that may allow them to access, e.g., a web site operated by the consolidator. On the web site, the customer 50 may be given the opportunity to add to or modify the their information in customer database 524. For example, the web site may provide forms that allow the customer to: (1) list additional ones of their financial account numbers in alias record 524b; (2) join the loyalty programs of participating merchants 200p, which would then be listed in memberships record 524c; (3) change their identifying information (address, telephone number, etc.) in customer identification record 524d; (4) update or add to the demographic information (number of children, brand preferences, etc.) in demographic record 524e; or (5) provide other information which participating merchants 200p and/or the consolidator may find useful.

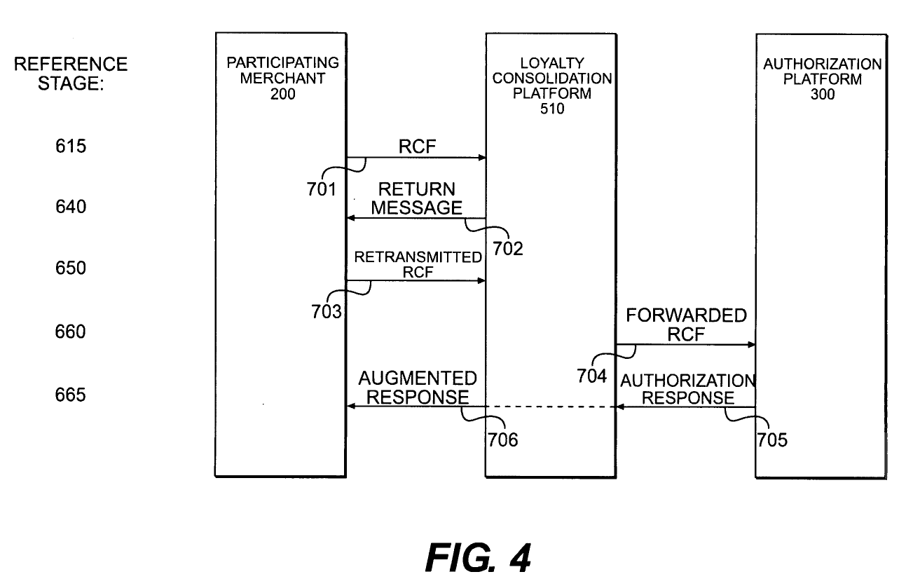

Consolidation platform 510 may use the data contained in merchant database 522 and/or customer database 524 to perform one or more methods consistent with the present invention, as discussed below. For example, upon inquiry from a participating merchant 200p, consolidation platform 510 may be configured to determine whether a particular customer 50 is a member of a loyalty program offered by that merchant, and to provide an indication of the result of this determination to the merchant. Exemplary methods by which consolidation platform 510 may make this determination are described below in connection with FIGS. 3-4.

FIG. 3 is a flow chart that illustrates an exemplary method for administering loyalty programs. Further, FIG. 4 is a diagram that illustrates an exemplary flow of messages between a representative participating merchant 230, consolidation platform 510 and authorization platform 300, consistent with the method of FIG. 3. While the exemplary method is described herein as a series of stages, it is to be understood that the order of the stages may vary in other implementations. In particular, non-dependent stages may be performed in any order, or in parallel.

Referring to FIG. 3, the exemplary method may begin when a customer 50 initiates a transaction with exemplary participating merchant 230 (stage 600). For example, customer 50 may present goods to a cashier in a store, or order goods or services from merchant 230 in person, by telephone, mail, facsimile, or over the Internet. Merchant 230 may then total the price of the goods or services, e.g., using transaction processor 204.

At stage 605, customer 50 may tender payment by providing the merchant 230 with the account number of a financial account that the customer wishes to settle the transaction. If the transaction is conducted in person, for example, the customer 50 may present a bank card or other access device 54 to be read by terminal 208. Alternatively, where the transaction is conducted by telephone, mail, or over the Internet, etc., the customer 50 may provide merchant 230 with information (e.g., account number, type of account, expiration date, etc.) sufficient to identify the financial account for charging purposes. If required by the issuer of the particular financial account (e.g., in the case of a debit card), customer 50 may also present their personal identification number (PIN) or other account password.

At stage 610, rewards processor 206 of merchant 230 may determine if any of the customer's current purchases would qualify for a reward, assuming that the customer 50 is a member of the merchant's loyalty program. For example, rewards processor 206 may apply loyalty program rules 202a to, e.g., a list of the customer's purchases compiled by transaction processor 204, and determine if any of the items would qualify the customer for a discount or other reward, if the customer 50 is a member of the merchant's loyalty program. If there are no such rewards, and if no other rewards are possible under the loyalty program rules 202a, i.e., loyalty program rules 202a do not provide for rewards based on the customer's history of transactions with the merchant (stage 610: NO), then there is no need to perform a loyalty check with respect to this transaction. In order to avoid unnecessary processing, terminal 208 may flag the request as a “retransmitted RCF” 703 (see FIG. 4), and processing may continue at stage 650, described below.

Conversely, if the loyalty program rules 202a indicate that the customer (assuming that they are a member) may earn rewards based on the current transaction or a history of transactions with merchant 230 (stage 610: YES), then processing may continue at stage 615. Because rewards processor 206 has not yet received an indication that the customer is in fact a member of the merchant's loyalty program, rewards processor 206 may not apply the rewards to the transaction at this point. Instead, rewards processor 206 may store the possible awards in a memory, and await the consolidation platform's return message 702 (at stage 640, below) before calculating any rewards.

Optionally, at stage 610, rewards processor 206 may search customer loyalty data 202b for a record of the customer's account number. For example, merchant 230 may maintain an alias record (not shown), similar to alias record 524b in customer database 524, which cross references their customers' financial account numbers to their respective LIDs for the merchant's loyalty program. If a record of the customer's account number is found, indicating that customer 50 is a member of the merchant's loyalty program, then rewards processor 206 may apply any rewards earned from the transaction and processing may continue, as at 650 below.

At stage 615, terminal 208 may transmit a request to capture funds (RCF) 701 (see FIG. 4) from the customer's account. The RCF 701 may be in a standard format for such requests, as used by authorization platform 300. For example, the RCF 701 may be placed in an ACH debit message format. If consolidation platform 510 is operated by the same entity that operates authorization platform 300, then the RCF 701 may be transmitted over the same channel that merchant 230 uses to transmit such request to the authorization platform 300. If this is not the case, then merchant 230 may instead transmit the request to consolidated platform 510 over a different channel, such that authorization platform 300 may not act on the request prematurely.

The RCF 701 may include information sufficient to identify, e.g., the issuer to which the RCF 701 is to be forwarded (e.g., by bank identification number (BIN)), the financial account from which funds are to be captured (e.g., by account number), and the amount of the funds that are to be captured. The RCF 701 may also identify the requesting merchant 230 (e.g., by MID). Terminal 208 may also save a copy of the formatted RCF 701 in a memory, for possible retransmission at stage 650, below.

At stage 620, consolidation platform 200 may receive the RCF 701 and decide whether to perform a loyalty check for this particular transaction. In some embodiments, consolidation platform 200 may perform a loyalty check on every RCF 701 that it receives. By way of example, this may be done where terminals 208 of participating merchants 200p are configured to send such requests to consolidation platform 510 and authorization platform 300 via separate channels. However, in order to reduce processing time, consolidation platform 510 may perform loyalty checks only for transactions that meet certain criteria.

For example, consolidation platform 510 may perform loyalty checks only on original RCFs 701 (i.e., as opposed to retransmitted RCFs 703—see stage 650, below). Consolidation platform 510 may identify the request as a retransmission by determining whether the request is flagged as a retransmitted RCF 703, as discussed below.

In some embodiments, consolidation platform 510 may receive requests to capture funds from both participating merchants 200p and non-participating merchants 200n, e.g., where the consolidator also operates authorization platform 300 on the same network 400. In such case, consolidation platform 510 may perform loyalty checks only on RCFs 701 transmitted by participating merchants 200p. For example, consolidation platform 510 may identify the requesting merchant, e.g., by extracting the MID or other merchant identifier from the RCF 701. After the requesting merchant has been identified, consolidation platform 510 may determine whether the requesting merchant is a participating merchant. For example, consolidation platform 510 may determine whether the requesting merchant's MID is indicated to be participating in record 522b.

Further, consolidation platform 510 may perform loyalty checks only on requests related to accounts issued by a particular entity, e.g., where consolidation platform 510 is affiliated with a particular issuer of financial accounts. In such case, consolidation platform 510 may determine whether the account used in the particular transaction is such an account. For example, consolidation platform 510 may extract the BIN from the RCF 701 and only perform a loyalty check if the BIN from the RCF 701 matches a BIN of the particular issuer.

If the RCF 701 fails to meet one or more of the criteria (stage 620: NO), then consolidation platform 510 may cease processing the RCF 701. In some embodiments, consolidation platform 510 may nevertheless capture data about the transaction (at stage 655), for storage in customer database 524. For example, consolidation platform 510 may search alias records 524b for the account number used in the transaction. If the account number is found in alias records 524b, then consolidation platform 510 may add data regarding the current transaction to transaction history record 524f. If the account number is not found, then consolidation platform 510 may create a new customer record in database 524 by assigning a CID to correspond to the account number, adding the account number to the alias record 524b for the new CID, and adding data regarding the current transaction to transaction history record 524f, e.g., by storing the account number, MID, and transaction price. Consolidation platform 510 may also obtain additional information regarding the customer's identification and or demographic information, e.g., by request to a credit reporting agency, or sources of public information. Consolidation platform 510 may then add such information to the appropriate records 524d and/or 524e.

After capturing such data, consolidation platform 510 may then forward the RCF 701 to authorization platform 300 (at stage 660), either directly (where such a connection exists), or over network 400. Processing may then continue at stage 665, as described below.

If the RCF 701 meets all of the applicable criteria (stage 620: YES), then consolidation platform 510 may perform a loyalty check, at stage 625. In a loyalty check, consolidation platform 510 may determine whether the particular customer 50 is a member of a loyalty program offered by the requesting merchant 230. Consolidation platform 510 may make this determination by extracting the account number from the RCF 701 and searching database 524 for a cross-reference between the account number and the MID of the requesting merchant 230.

For example, consolidation platform 510 may search alias records 524b for the account number used in the transaction. If the account number is found in alias records 524b, then consolidation platform 510 may retrieve the memberships record 524c corresponding to the alias record 524b in which the account number was found. Consolidation platform 510 may then search memberships record 524c for a cross-reference to the requesting merchant 230. For example, consolidation platform may extract the MID from the RCF 701 and search the customer's memberships record 524c for that MID.

If a cross-reference is not found (stage 625: NO), then consolidation platform 510 may capture data from the transaction (as stage 655). Consolidation platform 510 may then forward the RCF 701 to the authorization platform 300 (at stage 660) and processing may then continue at stage 665.

If a cross reference is found (stage 625: YES), indicating that the customer is a member of the requesting merchant's loyalty program, then consolidation platform 510 may determine, at stage 630, whether the transaction price may change after the customer is given the loyalty reward. For example, consolidation platform 510 may retrieve the instant discount indication 522d for the requesting merchant 230 from database 522. If the instant discount indication 522d indicates that a change in price is not possible (stage 630: NO), then consolidation platform 510 may flag the transaction as “LOYAL” (at stage 635), e.g., by saving the RCF 701 in a buffer 526 in storage device. Consolidation platform may then capture data from the transaction (as stage 655) and forward the RCF 701 to the authorization platform 300 (at stage 660). Processing may then continue at stage 665. Alternatively, consolidation platform 510 may transmit a return message 702, indicating that the customer 50 is a member of the merchant's loyalty program (as at stage 640).

If the instant discount indication 522d indicates that a change in price is possible (stage 630: YES), then consolidation platform 510 may cancel the RCF 701 and transmit a return message 702 to the requesting merchant 230 over network 400, indicating that the customer is a member of their loyalty program (at stage 640). In order to provide backward compatibility with existing systems, consolidation platform 510 may transmit the return message 702 to the requesting merchant 230 in the same format that authorization platform 300 uses to transmit authorization responses (discussed below). In this manner, merchants 200 may join the consolidated system 500 without having to purchase new hardware for terminals 208. For example, consolidation platform 510 may transmit the message “LYL” or “LOYAL,” depending on how many characters are made available for such purposes in the message format. The return message 702 may be a numeric or other code that may be interpreted by terminals 208 in accordance with a code key contained in a memory.

In some embodiments, the return message 702 may also include the requesting merchant's own LID for the customer. For example, consolidation platform 510 may search the customer's membership record 524c for the customer's LID for the requesting merchant 230. If such an LID is found, then consolidation platform 510 may add this information to the return message 702 for transmission to the requesting merchant 230.

However, the return message 702 is not limited to these items of information, and consolidation platform 510 may transmit other information that may be of interest to the requesting merchant 230. For instance, consolidation platform 510 may also transmit a customer history message to the requesting merchant 230.

In one embodiment, for example, consolidation platform 510 may search standing orders record 522e to determine whether the requesting merchant 230 has any standing requests for information regarding its customers. For example, a participating merchant 200p may have a standing request that consolidation platform 510 indicate if it has information that their “loyal” customers have recently transacted with one of the merchant's non-participating competitors. Alternatively, a participating merchant 200p may have a standing request that consolidation platform 510 indicate if it has information that their customers have recently transacted with the merchant or one of the merchant's affiliates. As another example, a participating merchant 200p (e.g., an automobile supply) may have a standing request that consolidation platform 510 indicate if it has information that their customer has made a certain type of major purchase (e.g., a new automobile). If any such requests are present, then consolidation platform 510 may retrieve the information necessary to fulfill the request, e.g., from transaction history record 524f. Consolidation platform 510 may then add such information to the return message 702. Alternatively, consolidation platform 510 may transmit such information in a separate message.

At stage 645, the return message 702 may be received by the requesting merchant's terminal 208. In an exemplary embodiment, terminal 208 may be configured to recognize the return message 702 and prompt rewards processor 206 to automatically apply the merchant's loyalty rewards to the transaction. For example, rewards processor 206 may apply any rewards (e.g., discounts) that were stored in memory when the transaction was totaled (at stage 610, above).

In an exemplary embodiment, rewards processor 206 may also determine if the return message 702 contains the requesting merchant's LID for the customer 50. If so, then rewards processor 206 may search the merchant's customer loyalty data 202b for the customer's record, and apply any rewards due the customer based on their history of transactions with the merchant.

Further, rewards processor 206 may also determine if the return message 702 contains any response to the merchant's standing orders. If so, then terminal may apply further rewards to the transaction. For example, if the return message 702 indicates that the customer 50 recently did business with one of the requesting merchant's competitors, then rewards processor 206 may print a coupon that the customer may use on a future visit to the merchant. In this manner, loyalty consolidation system 500 may help the requesting merchant 230 regain their customer's loyalty for the future. Alternatively, if the return message 702 indicates that the customer recently did business with one of the merchant's affiliates, then rewards processor 206 may print a coupon for use at that affiliate. In this manner, loyalty consolidation system 500 may help the requesting merchant 230 reinforce the customer's loyalty toward its affiliates.

At this time, rewards processor 206 may also update the customer's record in the requesting merchant's loyalty database 202. For example, rewards processor 206 may update the customer's loyalty data 202b to reflect the purchases made in this transaction and, e.g., increment the customer's frequency of visits and/or credit toward bonus items as necessary.

Rewards processor 206 may also update the consolidated transaction history record 524f in customer database 524. For example, rewards processor 206 may transmit certain items of information (brands purchased, types of purchases, etc.) that participating merchants 200p and/or customer 50 permit to be shared with the consolidator and/or other participating merchants 200p. Terminal 208 may append this information to the retransmitted RCF 703 (see stage 650, below). Alternatively, terminal 208 may transmit this information to consolidation platform in a separate message.

At stage 650, terminal 208 may “retransmit” RCF 701. This retransmission is termed a “retransmitted RCF” 703. However, in some embodiments, the retransmitted RCF 703 may be in a different format and/or transmitted over a different channel than the original RCF 701. If the rewards earned by the customer resulted in a reduced transaction price, then the retransmitted RCF 703 may contain the reduced transaction price in place of the transaction price submitted with the original RCF 701. In some embodiments, other data related to the transaction may also be appended to the retransmitted RCF 703. For example, terminal 208 may append information intended for entry into the customer's consolidated transaction history record 524f (as at stage 645). Otherwise, the retransmitted RCF 703 may contain the same information (e.g., account number, BIN, MID) that was contained in the original RCF 701.

If the requesting merchant 230 communicates with both authorization platform 300 and consolidation platform 510 over the same channel, then terminal 208 may also flag the retransmitted RCF 703 as a retransmission, e.g., by adding a retransmission flag, thus alerting consolidation platform 510 to the fact that this is a retransmitted RCF 703 (as opposed to an original RCF 701). Processing may then continue at stage 620, as described above. Alternatively, if the requesting merchant 230 communicates with authorization platform 300 and consolidation platform 510 over separate channels, then terminal 208 may transmit the retransmitted RCF 703 to authorization platform 300 over its separate channel. Processing may then continue at stage 665, as described below.

When consolidation platform 510 receives retransmitted RCF 703 it may recognize the request as a retransmission. For example consolidation platform 510 may recognize the presence of the retransmission flag. Alternatively, consolidation platform 510 may recognize the retransmitted RCF 703 based on the fact that it is the second transmission of a request to capture funds from the same account, by the same merchant 230, with the same (or a reduced) transaction price, within a certain period of time. Consequently, consolidation platform 510 may determine not to perform a loyalty check on the retransmitted RCF 703 (stage 620: NO). Consolidation platform 510 may proceed to capture any customer history information appended to the request by entering it into the customer's consolidated transaction history record 524f. Consolidation platform 510 may then forward the retransmitted RCF 703 directly to authorization platform 300. If consolidation platform 510 and authorization platform 300 are not operated by the same entity, consolidation platform 510 may strip the retransmission flag and/or any appended information (if present) from the retransmitted RCF 703, in order to ensure that the forwarded RCF 704 is in a format compatible with authorization platform 300.

At stage 665, authorization platform 300 may receive the forwarded RCF 704 (whether original or retransmitted) and determine if the request should be authorized. First, authorization platform 300 may determine if the account number corresponds to a valid financial account. For example, authorization platform 300 may extract the account number and/or BIN from the forwarded RCF 704 and search account database for the corresponding account.

If no corresponding account is found, then authorization platform 300 may return an error message to the requesting merchant 230. If the corresponding account is found, then authorization platform 300 may determine whether the account is in good standing and if the account's credit (or debit) balance is greater than the transaction price, e.g., by comparing the transaction price to the amount the customer's account has “available to promise.” Authorization platform 300 may then transmit an appropriate authorization response 705 (e.g., APPROVED or DECLINED). If the request is approved, then the authorization response 705 may also include an authorization code that serves as the merchant's proof of authorization.

Authorization platform 510 may return the authorization response 705 to the requesting merchant 230, either directly or through consolidation platform 510. If the authorization response 705 is returned to the requesting merchant 230 through consolidation platform 510, then consolidation platform 510 may append certain information to the response.

For example, if the customer was flagged as “LOYAL” but no return message 702 indicating this fact was previously sent (e.g., because the rewards offered by merchant 230 would not affect the transaction price, as described at stages 630-635, above), then consolidation platform 510 may augment the authorization response 705, e.g., by appending a message to the response 705. This augmented response 706 may contain an indication that the customer is a member of the requesting merchant's loyalty program and/or other information (e.g., as in the return message 702 at stage 640, above). The appended message may be recognized by the merchant's terminal 208 and rewards processor 206 may apply the merchant's loyalty program rules 202a (as at stage 645, above; note however, that, in this case, such rewards will not affect the transaction price).

The requesting merchant 230 may then complete the transaction (at 670) with the customer by giving the customer any reward certificates that they may have earned for the transaction and/or printing a receipt showing the number of reward points or discounts they have earned for this transaction. Finally, authorization platform 300 may transfer an amount of funds equal to the transaction price from the issuing financial institution to the requesting merchant 230, so as to settle the transaction on customer's behalf.

As described above, embodiments of the present invention provide systems and methods by which a plurality of merchants can participate in a consolidated loyalty system that offers customers access to the benefits of membership in the individual merchants' loyalty programs using a single access key, such as the account number of a bank card. Further, systems and methods consistent with embodiments of the present invention allow individual merchants participating in the consolidated loyalty system to provide rewards to their customers at the point of sale. In addition, systems and methods consistent with embodiments of the present invention facilitate the sharing of customer data between participating merchants. Consequently, such systems and methods may solve one or more of the deficiencies of conventional methods for providing access to loyalty or rewards programs.

Other embodiments will be apparent to those skilled in the art from consideration of the specification and practice of the disclosed embodiment and aspects of the invention, as presented herein. It is intended, therefore, that the specification and examples be considered as exemplary only, with a true scope and spirit of the invention, being indicated by the following claims.

What is claimed is:

1. A method for processing a request, the method comprising:
receiving, at a consolidation platform, a request from a merchant to capture funds from a customer's financial account;
determining, at the consolidation platform, whether the customer is a member of a loyalty program offered by the merchant based on the request to capture funds;
if the customer is a member of a loyalty program offered by the merchant, providing an indication of the customer's membership to the merchant; and
if the customer is not a member of a loyalty program offered by the merchant, forwarding the request for authorization.

2. The method of claim 1, wherein receiving a request comprises:
receiving a request from one merchant of a plurality of merchants in communication with the consolidation platform over a network; and
identifying the one merchant based on the request.

3. The method of claim 2, wherein the network is an automated clearinghouse network.

4. The method of claim 1, wherein receiving a request comprises receiving information identifying the financial account.

5. The method of claim 4, wherein:
receiving a request further comprises receiving information identifying the merchant; and
determining whether the customer is a member comprises searching for a cross-reference between the merchant and the account.

6. The method of claim 1, wherein determining whether the customer is a member of a loyalty program comprises searching a database for a cross-reference between the customer and the merchant's loyalty program.

7. The method of claim 1, wherein providing an indication of the customer's membership comprises:
transmitting a message to the merchant including the indication; and
canceling the request to capture funds.

8. The method of claim 7, wherein the message further includes information related to a transaction by the customer with another merchant.

9. The method of claim 1, wherein forwarding the request for authorization comprises forwarding the request to an automated clearinghouse.

10. The method of claim 1, wherein the financial account is one of a debit account and a credit account.

11. A system comprising:
a consolidation platform, the consolidation platform in communication with a plurality of merchants over a network, the consolidation platform comprising a processor, the processor configured to:
receive a request from one of the plurality of merchants to capture funds from a customer's financial account;
determine, based on the request, whether the customer is a member of a loyalty program offered by the merchant; and
if the customer is a member of a loyalty program offered by the merchant, provide an indication of the customer's membership to the merchant over the network; and
if the customer is not a member of a loyalty program offered by the merchant, forward the request for authorization to an authorization platform for processing of the request.

12. The system of claim 11, wherein the processor is further configured to identify the one merchant based on the request.

13. The system of claim 11, wherein the network is an automated clearinghouse network.

14. The system of claim 11, wherein the request comprises information identifying the financial account.

15. The system of claim 14, wherein:
the request further comprises information identifying the merchant; and
wherein the processor is configured to determine whether the customer is a member by searching for a cross-reference between the merchant and the account.

16. The system of claim 11, wherein the processor is further configured to determine whether the customer is a member of a loyalty program by searching a database for a cross-reference between the customer and the merchant's loyalty program.

17. The system of claim 11, wherein, if the customer is a member of a loyalty program offered by the merchant, the processor is configured to:
transmit a message to the merchant over the network, the message including the indication; and
cancel the request to capture funds.

18. The system of claim 17, wherein the message further includes information related to a transaction by the customer with another merchant.

19. The system of claim 11, wherein the authorization platform comprises an automated clearinghouse.

20. The system of claim 11, wherein the financial account is one of a debit account and a credit account.

21. A computer-readable media containing instructions for configuring a processor to perform a method for processing a transaction request, the method comprising:
receiving a transaction request for a merchant to capture funds from a customer's financial account;
determining, based on the request, whether the customer is a member of a loyalty program offered by a merchant;
if the customer is a member of a loyalty program offered by the merchant, providing an indication of the customer's membership to the merchant; and
if the customer is not a member of a loyalty program offered by the merchant, forwarding the request for authorization.

22. The computer-readable media of claim 21, wherein receiving a request comprises:
receiving a request from one merchant of a plurality of merchants in communication with the processor over a network; and
identifying the one merchant based on the request.

23. The computer-readable media of claim 21, wherein receiving a request comprises receiving information identifying the financial account.

24. The computer-readable media of claim 23, wherein:
receiving a request further comprises receiving information identifying the merchant; and
determining whether the customer is a member comprises searching for a cross-reference between the merchant and the account.

25. The computer-readable media of claim 21, wherein determining whether the customer is a member of a loyalty program comprises searching a database for a cross-reference between the customer and the merchant's loyalty program.

26. The computer-readable media of claim 21, wherein providing an indication of the customer's membership comprises:
transmitting a message to the merchant including the indication; and
canceling the request to capture funds.

27. The computer-readable media of claim 26, wherein the message further includes information related to a transaction by the customer with another merchant.

28. The computer-readable media of claim 21, wherein forwarding the request for authorization comprises forwarding the request to an automated clearinghouse.

29. The computer-readable media of claim 21, wherein the financial account is one of a debit account and a credit account.
